(19) United States
(12) Patent Application Publication
(10) Pub. No.: US 2013/0331024 A1
(43) Pub. Date: Dec. 12, 2013

(54) Retrofit Flap Damper Assembly System for Cone Type Damper Variable Air Volume Boxes

(71) Applicant: Daniel Plew, SR., Milwaukee, WI (US)

(72) Inventor: Daniel Plew, SR., Milwaukee, WI (US)

(21) Appl. No.: 13/540,474

(22) Filed: Jul. 2, 2012

Related U.S. Application Data
(63) Continuation-in-part of application No. 13/492,604, filed on Jun. 8, 2012.

(51) Int. Cl. F24F 13/10; B23P 19/04

(52) U.S. Cl. CPC F24F 13/10; B23P 19/04
USPC 454/333; 29/428; 29/525.02

(57) ABSTRACT

A retrofitting flap damper assembly system for cone type damper variable air volume (VAV) boxes includes specifically modified mounting hardware to secure a flap damper assembly inside an existing cone type damper VAV box. A plurality of bolts secure the flap damper in place using saddle brackets.

### CROSS-REFERENCE TO RELATED APPLICATIONS

This application claims priority to U.S. Non-Provisional application Ser. No. 13/492,604, filed on Jun. 8, 2012.

### FIELD OF INVENTION

The present invention relates to the field of variable volume boxes, and more specifically to a retrofitting system to replace current variable air volume boxes containing cone type dampers.

### BRIEF DESCRIPTION OF THE DRAWINGS

FIG. 1 illustrates an exemplary retrofit flap damper assembly system used in a cone type damper variable air volume (VAV) box.

FIG. 2a is an exemplary retrofit flap damper assembly in open position.

FIG. 2b is an exemplary retrofit flap damper assembly in closed position.

FIG. 3 is an exploded view of a retrofit flap damper assembly system for use with a VAV box.

FIG. 4 illustrates a retrofit flap damper assembly system using saddle brackets.

FIG. 5 is an exemplary saddle bracket.

### GLOSSARY

As used herein, the term “cone type damper” or “trumpet damper” refers to a type of damper which may be used in a VAV box and includes a moving diaphragm and actuator to control airflow.

As used herein, the term “flap damper” refers to a type of damper which may be used in a VAV box and includes a rotating or pivotal flap to control airflow.

As used herein, the term “HVAC” or “heating, ventilation and air conditioning” refers to the technology of indoor climate control.

As used herein, the term “saddle bracket” refers to a contoured bracket containing an aperture approximately perpendicular to the bracket wall for a bolt.

As used herein, the term “variable air volume box” or “VAV box” to a zone-level flow control device for an HVAC system. VAV boxes include a damper and an actuator.

### BACKGROUND

Variable air volume (VAV) boxes control the airflow at the zone-level for HVAC systems using a damper and an actuator. When in cooling mode, as a zone's target temperature is reached, the actuator moves the damper to a closed position to limit the flow of cool air into the space. As the zone's temperature increases, the actuator moves the damper to an opened position, allowing air to flow to bring the zone's temperature back down. VAV boxes may contain heating elements, which allow the boxes to operate similarly in heating applications.

One style of VAV box known in the art is a cone type, or trumpet type, box. These boxes use a cone or trumpet type damper, like a diaphragm, which is moved along a shaft to change the amount of airflow, and provide very good control. However, because of the multiple moving components, these cone type VAV boxes are known to be prone to failure. Actuators, gears and electrical components used to control the diaphragm break frequently and need to be replaced.

Another problem with cone type VAV boxes is the lack of access to internal components to allow servicing of the unit. When a cone type VAV box does need repair, a technician must cut a hole (or multiple holes) in the unit's housing to reach the internal components. Some VAV boxes include an access panel, but the space provided by the access panel is usually insufficient to accommodate a technician's hands and tools for the repairs.

It is also expensive to repair cone type VAV boxes. On average, it costs upwards $2,000, plus labor, to properly repair cone type VAV boxes.

A second style of VAV box known in the art is the flap damper type VAV box. Flap damper type VAV boxes use a flap damper with an actuator to control the airflow. Flap dampers are easier to maintain and repair than cone type dampers and are therefore more desirable. However, it costs thousands of dollars and hours of labor to replace an existing cone type VAV box with a new flap damper type VAV box.

Attempts to retrofit flap dampers in existing cone type VAV boxes have been made. For example, Trane provides a Round In/Round Out retrofitting kit which allows cone type VAV boxes to be fit with a flap damper. However, installing the new flap damper component requires that existing ductwork be disconnected so the damper may be inserted prior to the existing VAV box. The internal components of the existing cone type box must also be removed.

Other retrofitting designs use off-the-shelf components which are similarly secured to the outside of the existing cone type VAV box and either require significant ductwork and the removal of the interior components from the existing cone type VAV box or require additional ductwork to bypass the existing cone type VAV box.

Because the “retrofitted” flap damper used in current retrofitting solutions is mounted external to an existing cone type VAV box, additional space near the VAV box unit is required for both the new damper and required ductwork and the technician and required tools.

It is desirable to have a retrofitting system for cone type VAV boxes which require little or no duct work.

It is desirable to have a retrofitting system for cone type VAV boxes which secures a flap damper in the existing cone type VAV box.

### SUMMARY OF THE INVENTION

The present invention is a retrofitting flap damper assembly system for cone type damper variable air volume (VAV) boxes which includes specifically modified mounting hardware to secure a flap damper assembly inside an existing cone type damper VAV box. A flap damper having a housing with a front opening and a rear opening is secured in an existing cone type damper VAV box using either a bolt and back plate system or bolts with saddle brackets.

### DETAILED DESCRIPTION OF INVENTION

For the purpose of promoting an understanding of the present invention, references are made in the text to exemplary embodiments of a flap damper assembly system for cone type damper variable air volume (VAV) boxes, only some of which are described herein. It should be understood that no limitations on the scope of the invention are intended by describing these exemplary embodiments. One of ordinary skill in the art will readily appreciate that alternate but functionally equivalent materials, structures and components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale, instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

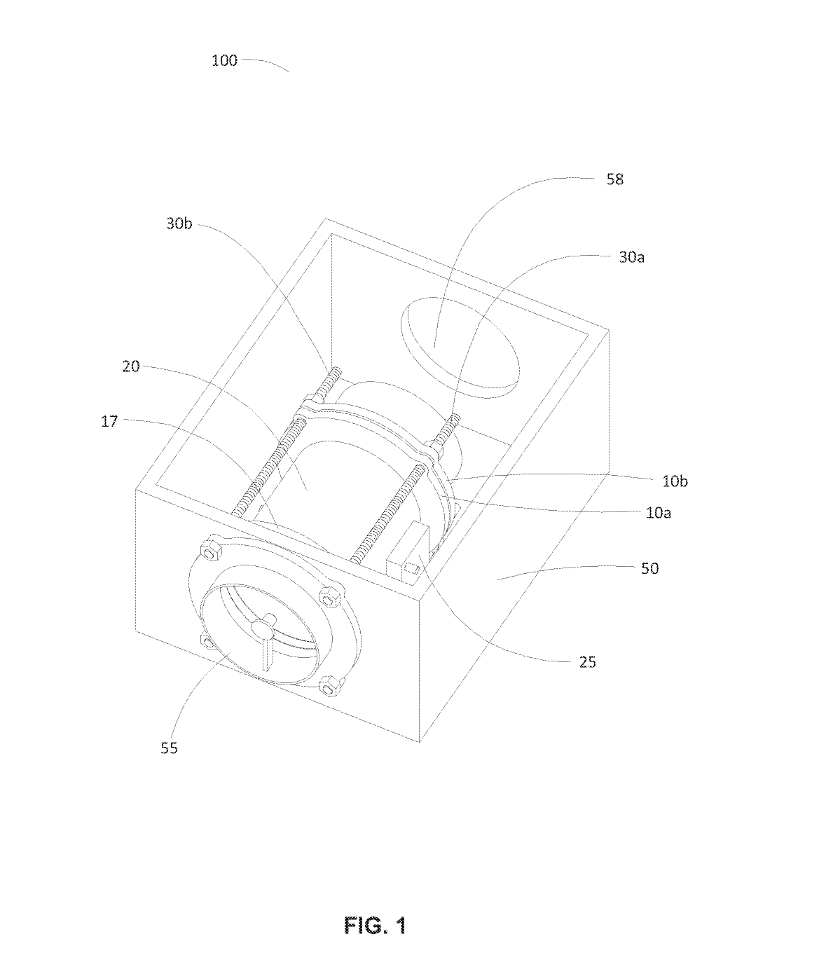

FIG. 1 illustrates an exemplary retrofit flap damper assembly system 100 used in a cone type damper variable air volume (VAV) box 50. Retrofit flap damper assembly system 100 includes back plates 10a, 10b, front plate 17, flap damper 20 with actuator 25 and bolts 30a, 30b (30c, 30d not shown). Other exemplary embodiments may omit front plate 17 and/or back plates 10a, 10b and use a plurality of saddle brackets to secure flap damper 20. VAV box 50 is an existing cone type damper VAV box with the cone type damper components removed and replaced by retrofit flap damper assembly system 100.

In the exemplary embodiment shown, flap damper 20 with actuator 25 is an off-the-shelf flap damper that includes actuator 25, such as the Honeywell MARD. In further exemplary embodiments, flap damper 20 may be a separate component from actuator 25. In still further exemplary embodiments, flap damper 20 and actuator 25 may be specifically designed to meet the specifications of a specific HVAC system or VAV box zone control being retrofitted.

Flap damper 20 with actuator 25 include fewer moving parts than a cone type damper and, as a result, are easier to maintain and repair. Flap dampers also have a longer functional life than cone type dampers.

Existing VAV box 50 will include wiring which powered the cone type damper components. Specifically, a cone type actuator will have three wires: one hot, one open and one closed. Actuator 25 may be configured to use the existing wiring, requiring little to no electrical work to retrofit existing cone type VAV box 50 with retrofit flap damper assembly system 100.

Existing VAV box 50 also includes inlet 55 to which retrofit flap damper assembly system 100 must be secured. Inlet 55 connects to the ductwork of the rest of the HVAC system. Existing VAV box 50 also has outlet 58 which connects to the outlet ductwork or zonal ductwork of the HVAC system.

In the exemplary embodiment illustrated in FIG. 1, existing cone type VAV box 50 is a completely closed rectangular prism. In order to access the interior components, a hole must be made in the housing. The hole may be sealed using a plate secured to the housing. In other exemplary embodiments, existing cone type VAV box 50 may include an access panel, allowing a mechanic or technician to easily access the interior components. However, in some instances, the access panel may be too small to accommodate the removal of cone type damper components and the replacement of those components with retrofit flap damper assembly system 100. The housing of existing VAV box 50 may need to be cut anyway.

Back plates 10a, 10b, front plate 17, bolts 30a, 30b (30c, 30d not shown) are each specifically configured components in order to properly secure flap damper 20 with actuator 25 within the existing VAV box 50. Back plates 10a, 10b and front plate 17 are rounded with tabs containing bolt apertures 14a, 14b, 14c, 14d. Back plates 10a,10b and front plate 17 a single piece of sheet metal having central apertures 12 (not shown) which have the same diameter as flap damper 20 and four bolt apertures 14a, 14b, 14c, 14d (not shown). Back plates 10a, 10b and front plate 17 are specifically sized to fit securely in existing VAV box 50.

In other exemplary embodiments, back plates 10a, 10b or front plate 17 may be made of any other material known in the art which may be used in a VAV box and can be used to secure a flap damper, with or without an actuator, to a VAV box.

Bolts 30a, 30b (30c, 30d not shown) are also specifically configured for retrofit flap damper assembly system 100. Existing cone type dampers include some bolts, but the bolts are not of sufficient length or durability to secure flap damper 20 with actuator 25 to back plates 10a,10b. As illustrated, bolts 30a, 30b (30c, 30d not shown) are slightly longer than flap damper 20 with actuator 25 adapted to engage inlet 55 and bolt apertures 14a, 14b, 14c, 14d (not shown).

In some exemplary embodiments, bolts 30a, 30b (30c, 30d not shown) may include sleeves, covers or other diameter-increasing structures to prevent back plates 10a, 10b and/or front plate 17 from moving along bolts 30a, 30b (30c, 30d not shown). In other exemplary embodiments, back plates 10a, 10b and/or front plate 17 may include tabs, interlocking members or other securing or stabilizing structures to prevent movement of back plates 10a, 10b and/or front plate 17 along bolts 30a, 30b (30c, 30d).

In other exemplary embodiments, bolts 30a, 30b (30c, 30d not shown) may includes physical structural modifications which prevent back plates 10a, 10b from moving, including, but not limited to, bevels, chamfers, lips, protuberances, grooves, tapered areas and other structural modifications and combinations of structural modifications may be used. In still further exemplary embodiments, bolts 30a, 30b (30c, 30d not shown) may include a surface texture to prevent back plates 10a, 10b from moving.

Similarly, in still further exemplary embodiments, other structures, for example, nuts, plugs, rings, seals, brackets, braces, and other similar structures and combinations of structures may be used to prevent back plates 10a, 10b from sliding on bolts 30a, 30b (30c, 30d not shown). However, the inclusion of additional components increases the complexity of a retrofit, and it is preferred that structures preventing or limiting the movement of back plates 10a, 10b be directly secured to bolts 30a, 30b (30c, 30d not shown) at least prior to the retrofit is started.

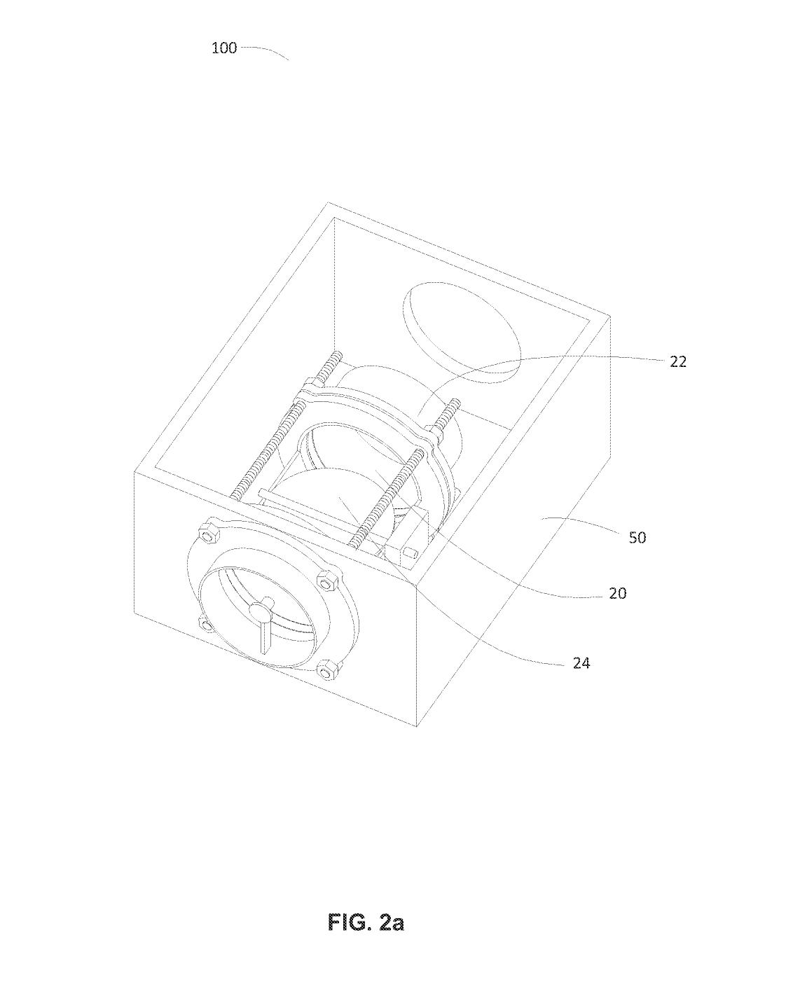

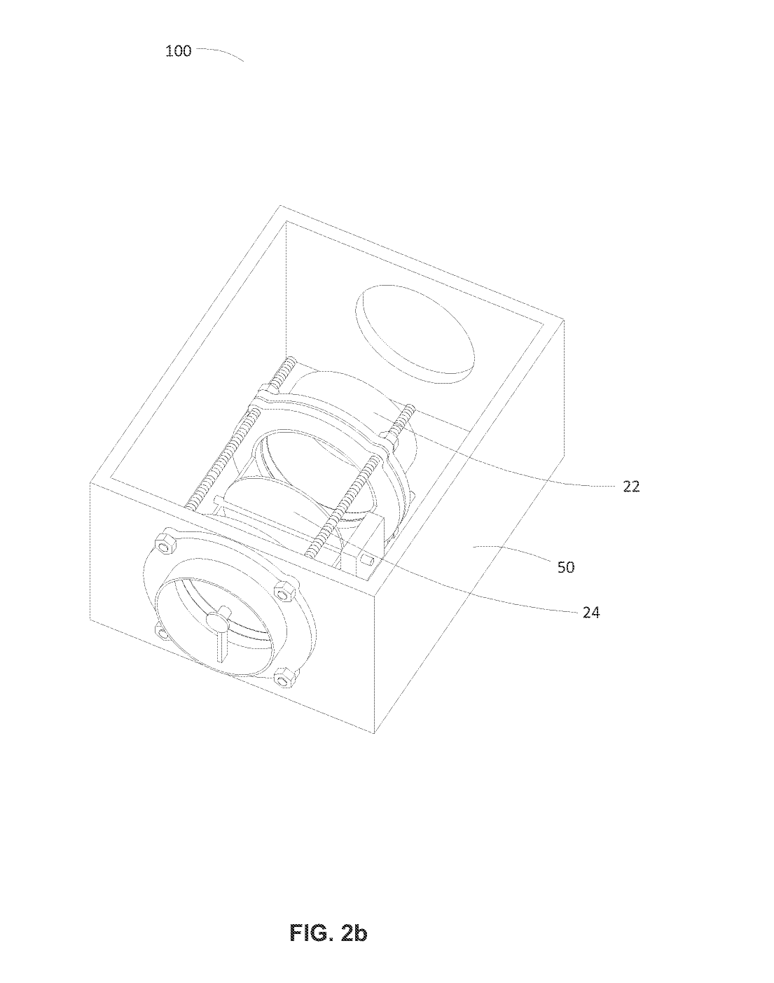

FIG. 2a is an exemplary retrofit flap damper assembly in open position. Housing 22 of flap damper 20 is shown in cut open so that flap 24 is visible. As illustrated, flap 24 is positioned parallel to airflow and housing 22, allowing the greatest amount of airflow through existing VAV box 50 as possible.

FIG. 2b is an exemplary retrofit flap damper assembly in closed position. As illustrated, flap 24 is positioned perpendicular to airflow and housing 22, preventing airflow through existing VAV box 50.

In some exemplary embodiments, flap damper 20 may also include a seal which increases flap's 24 ability to restrict airflow through existing VAV box 50 in the closed position. In some exemplary embodiments, the seal may be Styrofoam. However, in further exemplary embodiments, the seal may be made of any material known in the art to help create a more air tight seal around flap 24.

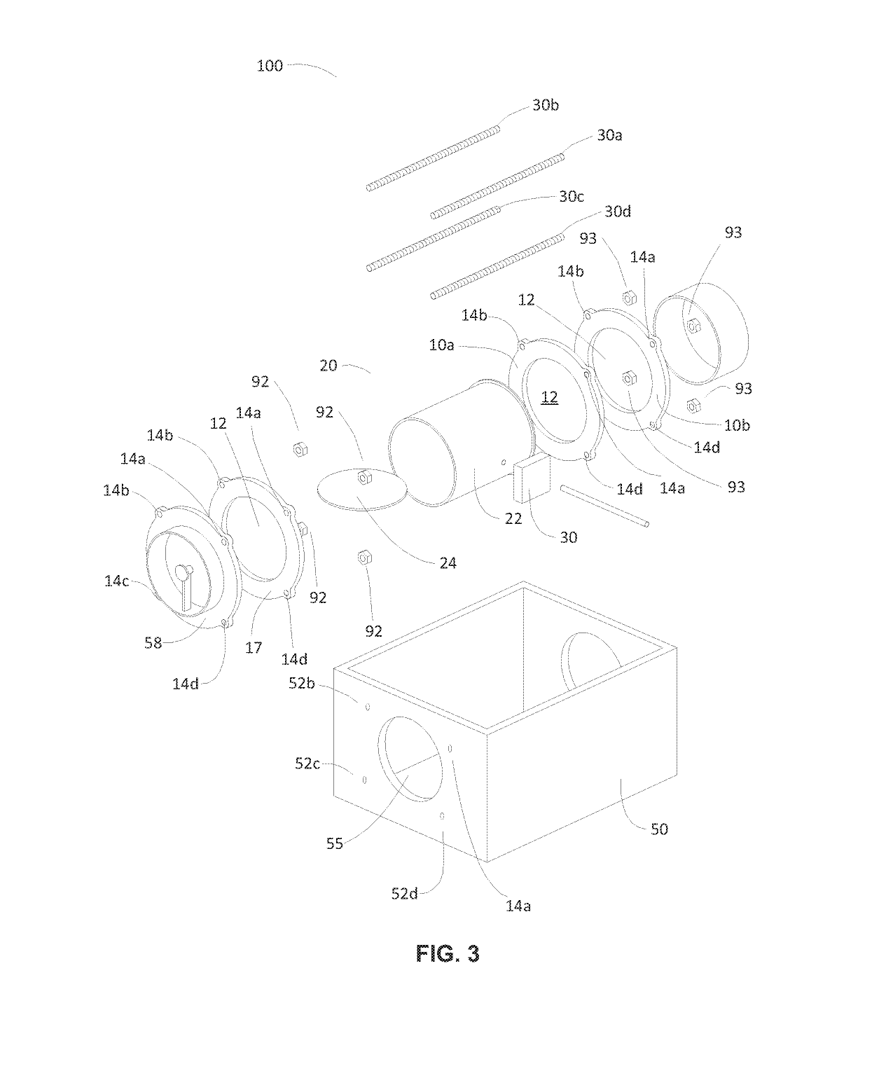

FIG. 3 is an exploded view of a retrofit flap damper assembly system 100 for use with existing cone type VAV box 50. In the exemplary embodiment shown, existing cone type VAV box 50 with inlet 55 is a standard 12 inch box known in the art. A standard 12 inch box has a 12 inch diameter inlet area, meaning housing 22 of flap damper 20 must also have a 12 inch diameter. Existing cone type VAV box 50, having a 12 inch diameter, is approximately 2 feet in length.

Also illustrated in FIG. 3 is inlet cover with flow sensor 58. In some exemplary embodiments, flow sensor may be separate from inlet cover. Inlet cover with flow sensor 58 senses airflow into existing VAV box 50 and provides feedback to actuator 30 to determine how flap 24 should be oriented.

In further embodiments, the size of existing cone type VAV box 50 may vary, as multiple sizes, ranging from 4 inch to 20 inch (as measured at inlet diameter) may be used. The size of existing cone type VAV box 50 will depend on the overall amount of airflow needed to meet the needs of the HVAC system. The size of housing 22 for flap damper 20 must similarly vary to correspond to the specific existing cone type VAV box 50. For example, the overall dimensions (e.g., length, width and height) will vary in order to accommodate the required airflow.

Existing VAV box 50 also contains bolt apertures 52a, 52b, 52c, 52d, through which bolts 30a-30d pass and are secured using nuts 92. Nuts 93 secure bolts 30a-30d at back plates 10a, 10b.

Back plates 10a, 10b and front plate 17 are specifically manufactured to correspond to the size of existing cone type VAV box 50, and central apertures 12 will vary proportionally to the size of existing VAV box 50. The specific location of bolt apertures 14a, 14b, 14c, 14d may also vary proportionally. Back plates 10a, 10b are located approximately 7 to 8 inches from the rear of existing VAV box 50 when existing VAV box 50 is a 12 inch box. As the size of existing cone type VAV box 50 changes, the distance between back plates 10a, 10b and the rear of existing VAV box 50 will change proportionally.

To correspond with the size of existing VAV box 50, bolts 30a, 30b, 30c, 30d are approximately 13 inches long. The exact length of bolts 30a, 30b 30c, 30d will vary depending on the size of existing VAV box 50. Bolts 30a, 30b 30c, 30d are threaded having nuts with corresponding threads.

In the exemplary embodiment shown, flap damper 20 with actuator 25 is a tubular structure with ends having consistent diameters. In further exemplary embodiments, one or both ends of flap damper may be tapered.

When installing retrofit flap damper assembly system 100, existing VAV box 50 is already installed in an existing heating and cooling system and contains the functional internal components of a cone type damper. The internal components must therefore be removed prior to installing retrofit flap damper assembly system 100. In some instances, it is possible to slide the existing cone type damper components out the inlet of the VAV box. In other embodiments, existing VAV box 50 may have an access panel or other opening to access the inside of existing VAV box 50. However, in other embodiments, an opening must be made by sawing, cutting, or other method known in the art to creating an opening in VAV box 50.

Once the internal components are removed, flap damper 20 with actuator 25 are positioned inside existing VAV box 50 and secured in place using back plates 10a, 10b, front plate 17 and bolts 30a, 30b, 30c, 30d. In some exemplary embodiments, actuator 25 may be located outside existing VAV box 50 or otherwise not directly attached to flap damper 20, as long as actuator 25 is operatively connected to flap damper 20 to provide power to flap 24 and direct its movement.

Front plate 17 is positioned so that its central aperture 12 aligns with inlet 55 of VAV box 50 and the front opening of housing 22 of flap damper 20. Similarly, back plates 10a, 10b are positioned so that their central apertures 12 align with the rear opening of VAV box 50 and provide a passage for air flowing through inlet 55 of existing VAV box 50.

In some exemplary embodiments, a sleeve may be placed over bolts 30a, 30b, 30c, 30d prior to securing flap damper 20 in existing VAV box 50.

After retrofit flap damper assembly system 100 is installed, the inlet to the VAV box 50 must be reassembled if the cone damper components were slid out the inlet, or the opening to existing VAV box 50 must be closed, whether by replacing an existing panel cover or repairing a hole created for the purpose of installing retrofit flap damper assembly system.

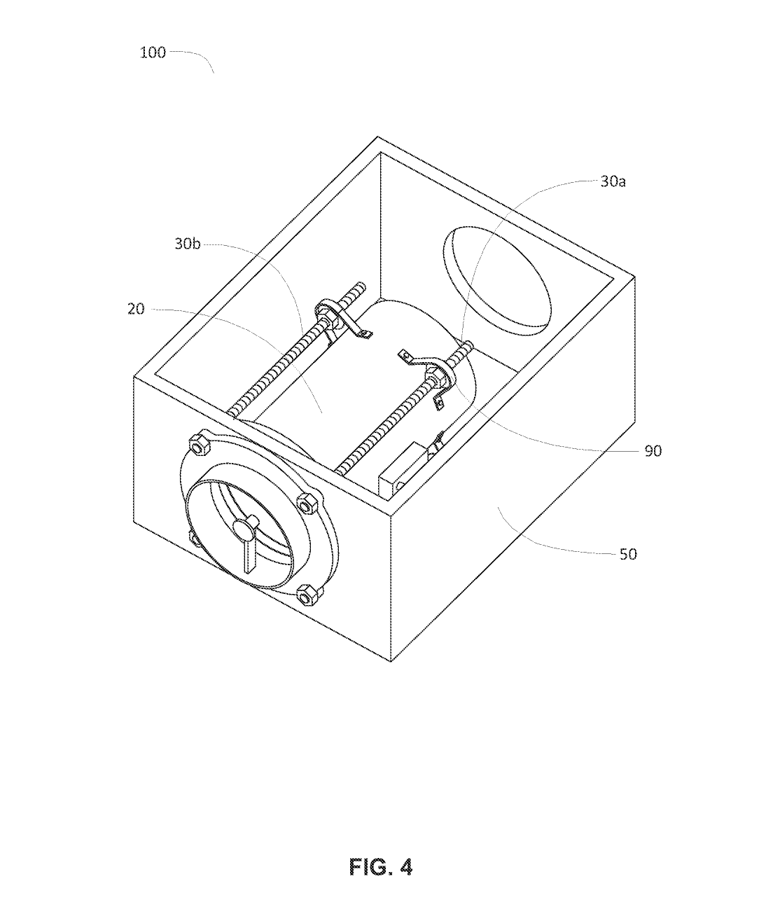

FIG. 4 illustrates an alternative exemplary embodiment of retrofit flap damper assembly system 100 which uses saddle bracket 90 with bolts 30a, 30b, 30c, 30d. As illustrated, retrofit flap damper assembly system 100 omits back plates 10a, 10b, and saddle brackets 90 secure bolts 30a, 30b (30c, 30d not shown) directly to flap damper 20 housing.

Because back plates are not required when saddle brackets 90 are used, the resulting retrofit flap damper assembly system 100 is significantly more streamlined. It is therefore easier to slide retrofit flap damper assembly system 100 through the inlet of existing VAV box 50, resulting in easier, quicker and less expensive installation.

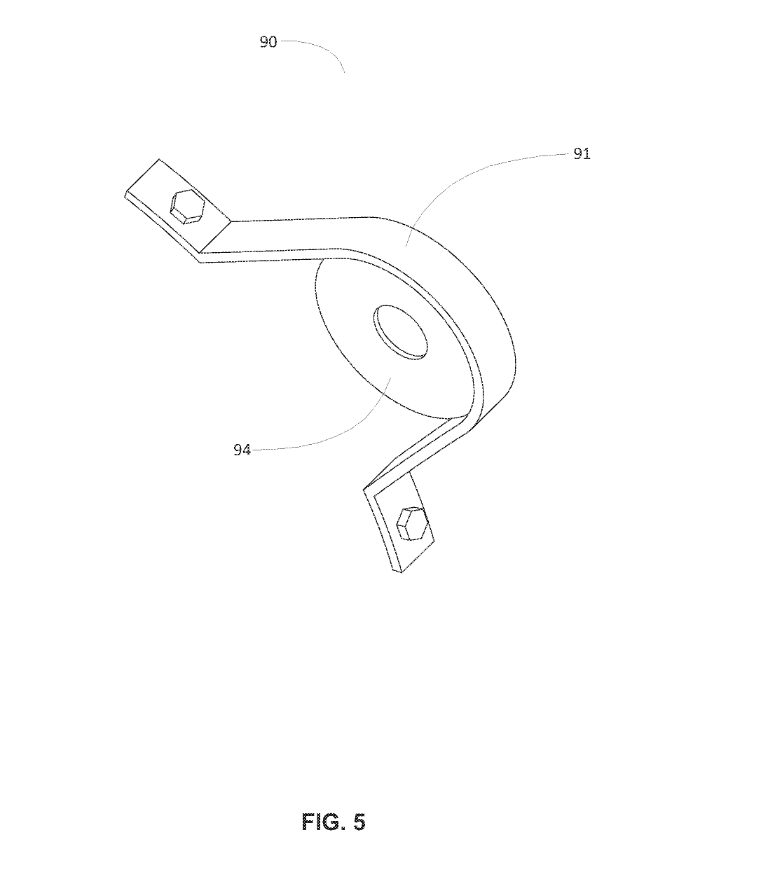

FIG. 5 is an exemplary saddle bracket 90 used with retrofit flap damper assembly system 100 (not shown). In the exemplary embodiment shown, saddle bracket 90 has a contoured base 91 with bolt aperture 94 approximately perpendicular to contoured base 91 on the inner surface of contoured base 91.

As illustrated in FIG. 5, bolt aperture 94 is perpendicular to contoured base 91. However, in further exemplary embodiments, bolt aperture 94 may be specifically manufactured to a desired angle which meets installation and assembly needs.

As illustrated, saddle bracket 90 is created by soldering or welding a washer onto a saddle bracket such as those known in the art. However, in further exemplary embodiments, saddle bracket 90 may be manufactured as a single component.

What is claimed is:

1. A retrofit flap damper assembly apparatus comprised of:
a flap damper having a housing with a front opening and a rear opening and a pivotal flap, wherein said flap damper is positioned between an inlet and an outlet of a cone type damper variable air volume box;
an actuator operatively connected to said flap damper;
at least one securing component having a plurality of bolt apertures selected from the group consisting of a back plate and a plurality of saddle brackets; and
a plurality of bolts passing through said bolt apertures of said cone type damper variable air volume box housing and said bolt apertures of said at least one securing component.

2. The apparatus of claim 1 wherein said plurality of bolts each include at least one nut.

3. The apparatus of claim 1 wherein said at least one securing component is a plurality of saddle brackets.

4. The apparatus of claim 3 wherein each of said saddle brackets is comprised of a contoured base with a bolt aperture on the inner surface of said contoured base.

5. The apparatus of claim 4 wherein said bolt aperture is perpendicular to said contoured base.

6. The apparatus of claim 4 wherein said bolt aperture is a washer permanently secured to said inner surface of said contoured base.

7. The apparatus of claim 1 which further includes at least one front plate between said inlet of said cone type damper variable air volume box housing and said flap damper with a central aperture aligned with said inlet of said cone type damper variable air volume box housing and said front opening of said flap damper.

8. The apparatus of claim 7 wherein said at least one front plate includes a plurality of bolt apertures through which said plurality of bolts pass.

9. The apparatus of claim 1 wherein said at least one securing component is a back plate.

10. The apparatus of claim 1 which includes four bolts, eight nuts and four saddle brackets.

11. The apparatus of claim 1 wherein said bolts have ends having a first diameter corresponding to the diameter of said bolt apertures and a middle section having a second larger diameter.

12. The apparatus of claim 1 wherein said cone type damper variable air volume box further includes at least one air flow sensor.

13. A retrofit flap damper system comprised of:
a cone type damper variable air volume box housing having an inlet and an outlet, wherein said cone type damper variable air volume box is connected at said inlet and said outlet to ductwork of an existing HVAC system;
a flap damper having a housing with a front opening and a rear opening and a pivotal flap, wherein said flap damper is positioned between said inlet and said outlet of said cone type damper variable air volume box;
an actuator operatively connected to said flap damper;
at least one securing component having a plurality of bolt apertures and selected from the group consisting of at least one back plate and a plurality of saddle brackets; and
a plurality of bolts passing through said bolt apertures of said cone type damper variable air volume box housing and said bolt apertures of said at least one securing component.

14. The system of claim 13 wherein said cone type dam per variable air volume box is connected at said inlet and said outlet to ductwork.

15. The apparatus of claim 13 wherein said inlet of said cone type damper variable air volume box has a diameter between 4 and 20 inches.

16. A method of retrofitting a cone type damper variable air volume box with a flap type damper comprising the steps of:
removing cone type damper components from the inside of a cone type damper variable air volume box;
positioning a flap damper fitted with at least one securing component in alignment with an inlet of said cone type damper variable air volume box;
wiring an actuator to existing wiring of said cone type damper variable air volume box; and
securing said flap damper aligned with said inlet of said cone type damper variable air volume box using a plurality of bolts.

17. The method of claim 16 wherein said at least one securing component is a plurality of saddle brackets.

18. The method of claim 17 which further includes the step of welding a washer to a contoured base to make said saddle brackets.

19. The method of claim 17 which further includes the step of securing said saddle brackets to the housing of said flap damper.

20. The method of claim 16 which further includes the step of creating an opening in the housing of said cone type damper variable air volume box to expose said cone type damper components.
